(19) United States
(12) Patent Application Publication
(10) Pub. No.: US 2013/0062087 A1
(43) Pub. Date: Mar. 14, 2013

(54) Machine Tool System, Especially a Jigsaw System

(71) Applicants: Thilo Koeder, Tokong (MY); Joachim Platzer, Remseck-Hochberg (DE); Ulli Hoffmann, Niefern-Oeschelbronn (DE)

(72) Inventors: Thilo Koeder, Tokong (MY); Joachim Platzer, Remseck-Hochberg (DE); Ulli Hoffmann, Niefern-Oeschelbronn (DE)

(73) Assignee: Robert Bosch GmbH, Stuttgart (DE)

(21) Appl. No.: 13/516,573

(22) PCT Filed: Oct. 26, 2010
(86) PCT No.: PCT/EP2010/066135

§ 371 Date: Oct. 1, 2012

(30) Foreign Application Priority Data
Dec. 18, 2009 (DE) 102009054976.5

(51) Int. Cl. B23D 51/16; B23D 49/10

(52) U.S. Cl. 173/2; 173/20

(57) ABSTRACT

A machine tool, especially a jigsaw, is disclosed. Angle deviations from a set angle position of the working tool are detected as the actual angle is adapted to the set angle by rotationally adjusting the working tool.

The invention relates to a machine tool system, especially a jigsaw system, according to the preamble to claim 1, and to an associated machine tool, configured especially as a jigsaw.

### PRIOR ART

Machine tools are known in a wide variety of embodiments and are used with very diverse driven work tools. These work tools have, in part, a flat cross section extending in their work plane and, as known especially from jigsaws for the saw blades thereof, are rotatable about a rotational axis and have to be set to mutually angled working directions running through this rotational axis. Such work tools, as well as saw blades, operate in contrast to rotary machine tools, such as milling cutters, on a direction-bound basis, yet in their working direction, by rotation, can also follow work lines or be aligned with work lines which have a non-straight course or a path which is offset relative to the work tool, insofar as, with such guidance along such a work line or alignment with such a work line, no radii which are small in comparison to the planar extent of the work tool in the working direction have to be passed through.

Even in the case of works along a straight running work line, on the one hand by dint of the workpiece, inter alia in dependence on the material structure, the material hardness, the workpiece thickness and the like, on the other hand, however, also by dint of the tool, for instance in dependence on the wear or the design of the working region of the work tool, forces can operate between the workpiece and the work tool, which forces result in rotation and/or twisting of the work tool. In particular, corresponding effects are obtained, inter alia due to the aforementioned influences in respect of work tools which, for the alignment and/or tracking of work lines, are rotatably supported in the machine tool. Thus, for instance, in jigsaws whose jigsaw blades are rotatable about a rotational axis lying parallel to their stroke axis, in particular coinciding with the stroke axis, and which, for the tracking of work lines, work in semiautonomous operation with optical pickup devices for a work lines respectively predefined by the workpiece, and in which the work tool, in pursuit of this work line, is aligned with the work line on a computer-aided basis, via appropriate adjusting devices, in terms of its rotational setting.

Any rotation of the work tool which leads to a deviation in the work angle of the saw blade relative to the respective target preset is apt to impair the desired work result.

### DISCLOSURE OF THE INVENTION

The object of the invention is to design and construct a machine tool system and, correspondingly, associated, in particular hand-held machine tools, such that such impairments of the work result are at least largely avoidable or avoided.

This is achieved with the features of claim 1 in relation to a machine tool system, and with respect to claim 4, in relation to the construction of system-compatible machine tools.

Both in work tools which are guided rotatably and in those which are guided non-rotatably by machine, and which have a tool plane aligned in the working direction, due to play—afflicted guidance of the work tool, as well as due to elasticities of the work tool or in the guidance thereof, the respectively predefined target angular position for the work tool can deviate from the factually given angular position as the actual angular position. If the actual angular position is registered, then such angular deviations, where necessary with the use of appropriate auxiliary devices, are identifiable, and, if need be, an appropriate “readjustment” can be made both by the user and, given suitable machine configuration, also by machine, so that the deviation from the predefined target angular position can be compensated by changing the actual angular position. Especially in hand-held machine tools such as jigsaws, which provide a rotatability of the work tool in alignment with or in pursuit of a respective work line, and thus, by dint of the work, are often exposed to conditions which impart torques to the work tool about its rotational axis, particular importance is attached to the registration of the respective actual angle, since the actual angle can be influenced, in the sense of a correction, by appropriate adjustment of the work tool.

Moreover, machine tools which are equipped in this way, i.e. machine tools such as jigsaws having rotatability of a tool in alignment with a respective work line, which tool, as a result of its shape, operates on a direction-bound basis, are frequently also provided with optical pickup devices and subordinate computer-assisted adjusting devices, so that they can work in semiautonomous operation, wherein the pickup devices provided for this purpose can also be used to register the respective actual angular position. Thus, at small additional expense, a corrective adjusting action is possible and, in particular, also a working operation in which identified deviations of the actual angle from the predefined target angular position can be compensated via a controlled system. This, where necessary, even when the respective work line is present only as a work line which has been predefined virtually, and thus has to be traced on a computer-aided basis, or has been predefined by other, workpiece-related orientation points, whereby, even in those cases in which correction actions are barely possible on the part of the user, an exact tracking of the respectively predefined work line can be achieved.

Even in simply designed machine tools, especially jigsaws, which are not adjustable in relation to the position of the work plane of their work tool, especially saw blade, relative to the machine, or which are adjustable about a rotational axis, situated in their work plane, relative to the machine, yet in which the adjustment about the rotational axis is performed by the user or is realized mechanically merely in alignment with a work line to be tracked, an improvement in work quality is achievable by virtue of the invention, since, based on the actual angle as the orientation variable, a preset for the guidance of the machine tool, especially jigsaw, is already given, which preset makes allowance for deviations from the predefined target angle. This orientation to the actual angle can be very easily represented in particular mechanically, where necessary also optically, mechanically, for instance, by virtue of the fact that, rotationally fixed relative to the rotational axis of the work tool, and thus rotationally fixed relative to the work tool in relation to the rotational axis, an indicating element, for instance an arrow, is provided, which, for the tracking of the respective work line, can be brought correctively into overlap with the work line. A corresponding notice function can also very easily be represented optically, for instance by a light source with appropriately bundled light beam, which light source rotates with the work tool about the rotational axis thereof and is aligned in the direction of the work line.

In design terms, such a solution can be realized with little complexity also in respect of work tools which are reciprocatingly driven, such as saw blades, if the respective indicating element, including the needle or the light source, is connected to a pivot bearing which forms a support to the machine, which support guides the work tool and is rotatable with the work tool, thus, for instance, in the case of jigsaws, an, in particular, lower stroke rod bearing, which is provided for the stroke rod guide of said jigsaws and is fixed relative to the machine in the stroke direction.

Further advantages and expedient embodiments can be derived from the claims, the description of the figures and the drawings, wherein:

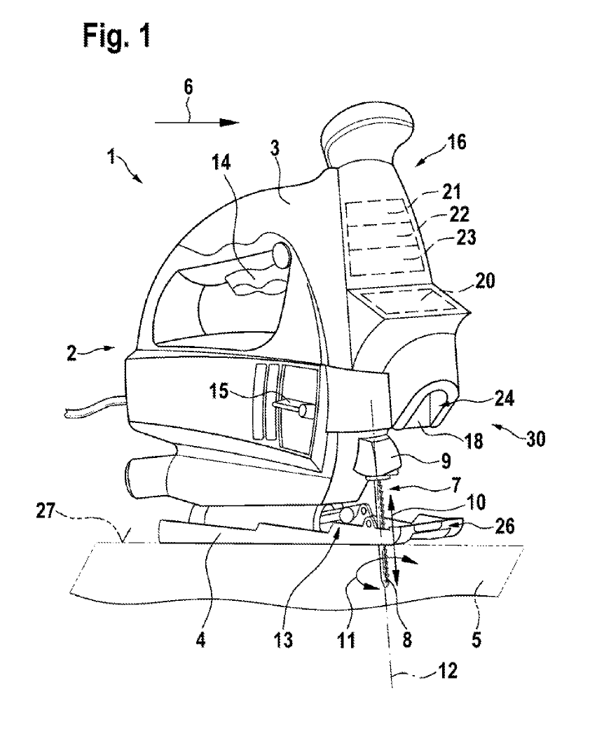

FIG. 1 shows as an example of a machine tool a schematic representation of a hand-held jigsaw,

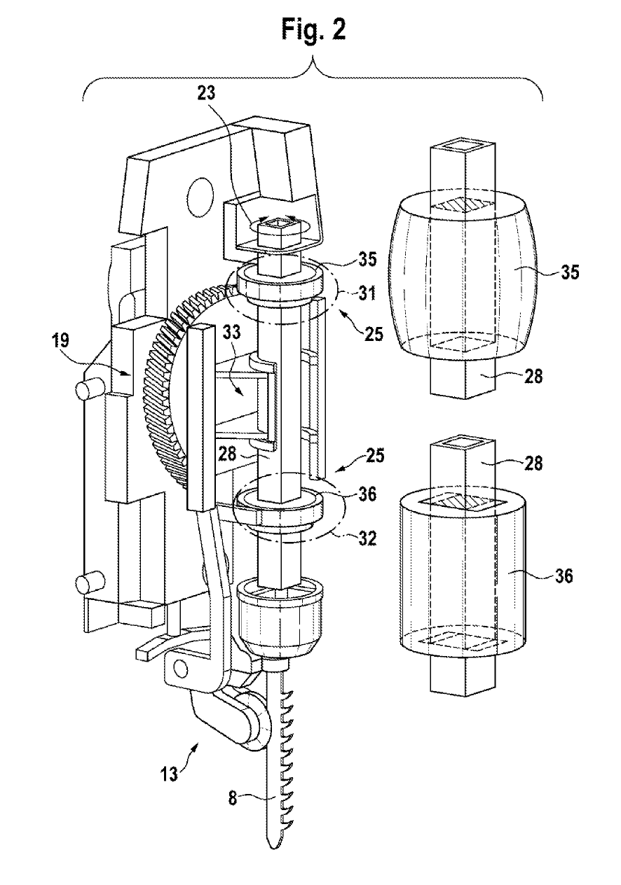

FIG. 2 shows in a detail, once again schematized, a representation of a part of the drive for the work tool formed by a saw blade,

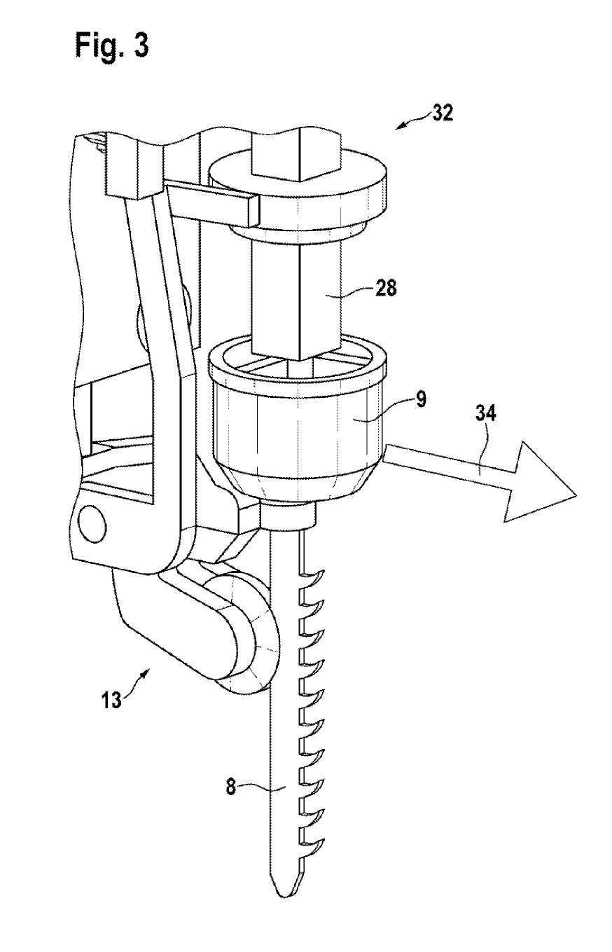

FIG. 3 shows an enlarged representation of the region III in FIG. 2,

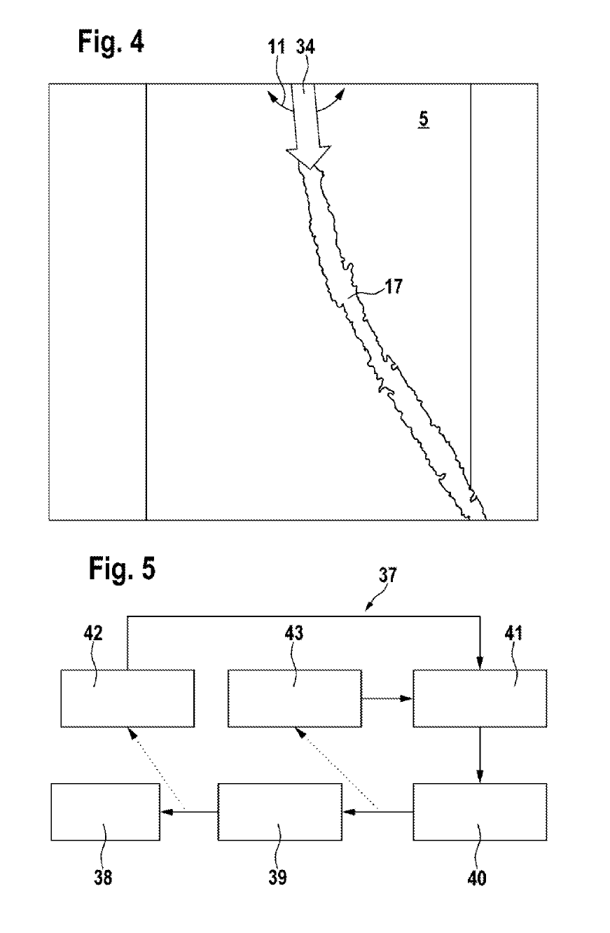

FIG. 4 shows a top view of the surface of a workpiece which is to be machined, having a work line to be tracked by the work tool, and

FIG. 5 shows in a block diagram the illustration of the control system, the indication and/or registration of the actual angle of the saw blade of the jigsaw, which saw blade is provided as the work tool.

FIG. 1 illustrates a hand-held jigsaw 2 as an example of a machine tool 1, which jigsaw is fitted with a work tool 7 that is fixed by its shaping to a work plane and, for the jigsaw 2, is formed by a saw blade 8. The jigsaw 2 has a housing 3, which is supported by a base plate 4 displaceably on the surface 27 of the workpiece 5. The saw blade 8, as the work tool 7, is held in a tool fixture 9 and is reciprocatingly driven in the direction of the arrow 10. In the representation, the stroke axis coincides with a rotational axis 12 about which, in relation to the represented illustrative embodiment, the saw blade 8 is rotatable in accordance with the arrow 11. Via the rotational position of the saw blade 8, the respective sawing direction is predefined as the working direction. The working direction indicated by the arrow 6 corresponds to the straight ahead working direction of the jigsaw 2, which, in the case of a non-rotated saw blade 8, overlaps with the work plane of the saw blade 8.

Accordingly, in FIG. 1, a control work setting of the jigsaw 2, which setting corresponds to the straight ahead working direction according to the arrow 6, is firstly shown; as a result of the rotatability of the saw blade 8, a further operating option for the jigsaw 2 is indicated, namely the operation thereof as a so-called “scrolling jigsaw”. In this operation, the jigsaw 2 operates in a working direction determined by the rotational position of the saw blade 8, i.e. semiautonomously at an angle in relation to the control work setting, which angle corresponds to the rotational position of the saw blade 8. In this operating mode, the saw blade 8 is mechanically aligned with a respectively predefined, straight or curved work line (FIG. 4) and follows this, wherein the user essentially only undertakes the support of the reaction forces resulting from the working operation and the advancement of the jigsaw 2.

In FIG. 1, the use of the jigsaw 2 in a so-called pendulum stroke mode is also illustrated. The saw blade is here adjusted in its pendulum motion, in the direction of its saw blade plane as the work plane, via a pendulum drive 13, on top of the stroke drive.

The portrayed operating modes are adjustable by the user via a switching device 15. The jigsaw 2 is switched on and off via a switching arrangement 14 provided in the handle region of the housing 3.

The semiautonomous working method comprising machine tracking of a work line 17 which is predefined in relation to the workpiece 5 requires means for the registration of this work line 17, which means in FIG. 1 are illustrated by an optical detection unit 30, which is provided in the front region 16 of the housing 3 offset in the forward direction relative to the saw blade 3 and is illustrated aligned with the saw blade 8 and with the workpiece-side working region of the saw blade 8. The optical detection unit 30 is illustrated by sensor systems 18 and 24, of which one is aligned in the direction of the rotational axis 12 of the saw blade 8, in particular in that region thereof which protrudes freely beyond the machine housing 3, while the other in particular and preferably is used to register the work line 17 to be tracked. These sensor systems 18, 24 can also, within the scope of the invention, be combined. Downstream, for the processing of the images registered via the sensor systems 18, 24 and, where necessary, other signals also, a data processor 21, a control unit 22, and at least one adjusting device 23 are provided, wherein, via the latter, in particular the work tool 7 in the form of the saw blade 8 is set to a respective rotational setting and/or is held in a respective rotational setting.

In FIG. 1, the arrangement of a display 20 in the front region 16 is also further illustrated, on which display, in particular, user-relevant information can be represented, whether concerning the alignment of the saw blade 8 relative to the work line 7, or other factors relating, in particular, to the rotational setting of the saw blade 8, including also the registration of the actual angle corresponding to the actual rotational setting of the saw blade 8, which actual angle can deviate from a predefined target angle respectively corresponding to the work preset, in particular corresponding to the alignment with the work line 17.

Such angular deviations can be operationally dictated by machine, tool and/or workpiece related factors, e.g. by the material structure of the workpiece, for example knotted or knot-free, the material type, the material hardness, the size of the rotational angle, the tool configuration, the tool wear or the like. This list alone reveals that such actual-target angular deviations can arise not only in jigsaws 2 with a saw blade 8, which is adjustable about a rotational axis 12 corresponding to their stroke axis, for the tracking of curved work lines, and is thus adjustable over larger angular ranges, but also in jigsaws 2 or corresponding machine tools 1 which basically are geared only to working in a single, predefined working direction, e.g. for control working operation and/or pendulum working operation.

The above-discussed deviations between actual and target angles, which arise, in particular, on a play-dependent or deformation-dependent basis, are small or very small in comparison to rotational angles necessary for the tracking of curved work lines. In particular, the registration of these angular differences requires, in addition to the target angle corresponding to the pursuit of the displacement preset, the registration of deviating actual angles, which, according to the invention, is preferably effected directly by measurement of the rotational setting of the saw blade 8, so that the rotational setting of the saw blade 8 can be realized in accordance with the deviation of the actual angle from the required, predefined target angle by appropriate rotation of the saw blade 8 or of the stroke rod guide of the saw blade 8.

Since the actual angle in the deviation from the predefined target angle is based on a torque of appropriate magnitude acting on the saw blade 8, within the scope of the invention, starting from empirically gained knowledge of the torque-dependent deviations of the actual angle from the predefined target angle, allowance is able to be made for these deviations, at least in a certain approximation, also through the consideration of a torque-dependent correction factor, and thus, for instance, the actual angle is respectively able to be corrected on the basis of the characteristic diagram, taking into account the deviation from the predefined target angle.

In FIGS. 2 and 3, the stroke drive 19 for the saw blade 8 as the work tool 7 of a machine tool 1 configured as a jigsaw 2 is shown in perspective and simplified representation. The stroke rod guide 25 for the saw blade 8 is further illustrated, which saw blade is connected by the tool fixture 9 to the stroke rod 28, which, for its part, has an upper stroke rod support 31 and a lower stroke rod support 32. Based on the illustrative embodiment according to FIGS. 1 to 3, comprising not only a stroke rod 28, which is driven in a reciprocating manner, for example via a cross slider crank mechanism 33 as the stroke drive 19, but also a saw blade 8, which is pivotable in the direction of the saw blade plane via the pendulum drive 13, the stroke rod supports 31 and 32 are preferably formed by mountings which, as additionally shown in enlarged representation, respectively have a bearing ring 35, 36 situated between the stroke rod 28 and the housing-side support. The bearing ring 35 of the upper stroke rod support 31 is provided with an inner contour corresponding to the stroke rod cross section and is held radially on the outside, in the style of pendulum bearings, designed as a spherical annular body, in an appropriate housing-side fixture. For the lower stroke rod support 32, the bearing ring 36 is provided, for instance, with an, in the direction of swing, longhole-shaped inner cross section matched to the stroke rod contour and is guided on the machine side such that it is concentrically rotatable about the stroke rod axis.

In this or a comparable manner, a stroke rod guide 25 is created, which can basically be used in jigsaws 2 which can be operated in each of said operating modes. That rotation of the stroke rod 28 about the axis 12 which is necessary to adapt the actual angle to the predefined target angle, and correspondingly also the rotational adjustment for a jigsaw 2 to be operated as a “scrolling jigsaw”, can be effected via an adjusting device 23, which, for example, acts on one of the bearing rings 35, 36 of the upper or lower stroke rod guide 31, 32, or even directly on the stroke rod 28. In principle, direct access to the stroke rod itself for the rotational adjustment is also possible.

The respective actual angle can likewise be registered by pickup directly at the stroke rod, one of the bearing rings, or else, as shown symbolically in FIG. 3 by means of the arrow 34, at the tool fixture 9. In practice, the arrow 34 can be formed, for instance, by a needle as indicating means, which needle, based on FIG. 1, projects, for instance, into the observation region of the optical detection unit 30 and thus not only directly indicates the respective actual angle, but also makes this available via the detection unit 30 for further conversion into a corresponding adjusting command for the adjusting device 23, so that the actual rotational setting of the saw blade 8 can be corrected in accordance with the deviation from the predefined target setting. An indication of the actual angle, for instance in comparison to the predefined target angle, can also be effected in the display 20, so that deviations in the guidance behavior for the jigsaw 2 can be taken into account by the user. Furthermore, due to possibly critical deviations between actual angle and predefined target angle, it is also possible to override the machine control system, and thus, for instance, alter the stroke rate.

In the block diagram according to FIG. 5, the structure of a control circuit 37 is illustrated, which control circuit adjusts the actual angle of the saw blade 8 to the predefined target angle, wherein the actual angle forms the sole control variable. The block 38 illustrates in the block diagram the saw blade 8 which is to be set to the predefined target angular position, and the block 39 illustrates the rotatable stroke rod 28, the angle of which is to be registered as the actual angle, wherein this angle can also analogously, where possible, be registered directly at the saw blade. The block 40 symbolizes the adjusting device—corresponding to the adjusting device 23 in FIG. 1—via which the stroke rod 28 is set in terms of its rotational setting to the predefined target angle. The block 41 symbolizes the control unit, for example as part of the data processor 21 in FIG. 1. In the block 42, the actual angle which is given on the stroke rod side (block 39) is registered, and in the block 43 the predefined target angle, which is set via the adjusting device 23 for the stroke rod 28, is registered. As a result, an actual angle respectively corresponding to the predefined target angle is achieved via the control system, wherein this happens independently of the fixing - dependent on the respective system—of the predefined target angle, since the actual angle forms the sole input variable for the control system.

All in all, according to the invention, an optimized alignment of the saw blade 8 with the respectively predefined target angle is thus achieved with simple means, and the preconditions for the attainment of an optimized work result are thereby created.

1. A machine tool system, comprising:
a driven work tool which is configured to be rotatable about a rotational axis and is further configured to be set to working directions which run through this rotational axis, and
a mechanism configured to register and/or indicate the respective working direction as the actual angle of the work tool.

2. The machine tool system as claimed in claim 1, wherein the actual angle, in terms of its deviation from a predefined target angle, forms the orientation variable for the alignment of the work tool in terms of its angular position with the predefined work line which is to be tracked with the machine tool and in pursuit of which the work tool is aligned at the predefined target angle.

3. The machine tool system as claimed in claim 2, wherein the mechanism includes a control device and an adjustment device, wherein the respective actual angle of the work tool is registered and is corrected via the control device in terms of its alignment with the predefined work line to be tracked and with the thereto corresponding, predefined target angle by the adjusting device.

4. A machine tool, comprising:
a driven work tool, which has a work plane and a working direction corresponding to the work plane and which is adjustable about a rotational axis transversely to the work plane and is configured to be set to mutually angled working directions running through the rotational axis and
a mechanism configured to indicate and/or register the respective actual angle of the driven work tool.

5. The machine tool as claimed in claim 4, wherein the mechanism is of mechanical configuration.

6. The machine tool as claimed in claim 5, wherein the mechanism includes an indicating element which is rotationally fixed relative to the work tool.

7. The machine tool as claimed in claim 4, wherein the mechanism is configured as an optical and/or a sensory mechanism.

8. The machine tool as claimed in claim 4, further comprising an optical detection unit aligned with the workpiece-side working region of the work tool, and/or with a sensor system for the rotational setting of the work tool and/or for a work line which is to be tracked on the workpiece side.

9. The machine tool as claimed in claim 6, wherein the mechanism includes a needle.
